(19) United States
(12) Patent Application Publication
(10) Pub. No.: US 2017/0266780 A1
(43) Pub. Date: Sep. 21, 2017

(54) METHODS FOR COOLING OF ABRASIVE GRINDING USING CARBON DIOXIDE

(71) Applicant: James Lohan, Perkasie, PA (US)

(72) Inventor: James Lohan, Perkasie, PA (US)

(21) Appl. No.: 15/441,648

(22) Filed: Feb. 24, 2017

Related U.S. Application Data
(60) Provisional application No. 62/310,041, filed on Mar. 18, 2016.

(51) Int. Cl. B24B 55/02; B23Q 11/10; B24B 21/04

(52) U.S. Cl. CPC B24B 55/02; B24B 21/04; B23Q 11/1061

(57) ABSTRACT

A method for cooling a workpiece that is typically metallic in nature that is undergoing a grinding operation by spraying liquid carbon dioxide at the workpiece. The liquid carbon dioxide is directed at the workpiece and form a carbon dioxide snow which will provide cooling and improve the efficiency of the grinding operation. Alternatively, the liquid carbon dioxide can be sprayed onto the back surface of the abrasive belt which will also provide the requisite cooling but help the belt from delaminating.

### CROSS REFERENCE TO RELATED APPLICATIONS

This application claims priority from provisional application Ser. No. 62/310,041, filed on Mar. 18, 2016.

### BACKGROUND OF THE INVENTION

Industrial grinding applications often cannot run with a liquid coolant for a variety of reasons such as the type of material to be finished, location and temporary nature of grinding operations and end product restrictions for example. The lack of liquid coolant on abrasives though can cause several problems. The failure to use coolant can create build up on the belt as small pieces of the swarf (grinding tailings) hot weld themselves to the belt. This decreases grinding efficiency and results in increased grinding times.

To overcome the increase in grinding time, pressure is increased of the item being ground to the grinding media (belt or wheel). This increase in pressure is performed to keep the grinding time from one item to the next and will substantially increase the heat being generated as well as increasing the power being consumed. This added friction also decreases the life of the grinding media belt or wheel. If the belt is uncooled, the belt material itself will heat up to the point that the belt starts to delaminate and pieces of the abrasive flak off.

A third problem with using no coolant is associated with the material being finished as some materials are temperature sensitive. Lack of coolant will overheat the material and create parts that must be rejected from a quality control perspective. Further the heat can also cause a change in the surface finish of the parts. Good cooling will generally create a smoother finish while poor cooling will often create more uneven or deeper grooves in the final surface finish.

The use of carbon dioxide cooling can help alleviate these problems by providing heat removal without the use of a liquid coolant. The process is dry, leaves no residue and is highly portable, which are all advantages over the use of liquids in cooling abrasive grinding operations.

### SUMMARY OF THE INVENTION

The present invention provides for a method to inhibit overheating and provide cooling of a workpiece during a grinding operation of the workpiece comprising spraying liquid carbon dioxide onto the workpiece.

The present invention further provides for a method to inhibit overheating of a workpiece during a grinding operation of the workpiece wherein the grinding operation is performed using an abrasive belt comprising spraying liquid carbon dioxide onto a back surface of the abrasive belt.

The liquid carbon dioxide that is directed onto the workpiece is fed from a source of liquid carbon dioxide to a nozzle where the liquid carbon dioxide expands upon contact with the atmosphere and form carbon dioxide snow which contacts the workpiece or the back of the abrasive belt.

The workpieces are typically metallic in nature and constitute a high dollar value product when finishing is complete. In a standard grinding set up, the grinding belt is held stationary and a robot will convey the workpiece of the moving abrasive to complete the finishing operation. There are however, certain cases in which the workpiece is unmovable and in these situations they grinding belt is moved on a carriage to perform the necessary process.

The liquid carbon dioxide can be supplied using a variety of sources. These sources include liquid siphon tube carbon dioxide cylinders, carbon dioxide containing dewars, and carbon dioxide bulk supply tank with associated piping. To achieve the necessary cooling, the carbon dioxide must be delivered at pressures and temperatures above the triple point in the liquid phase. The triple point constitutes a temperature of −56.6° C. and 5.11 atm. As the carbon dioxide exits a nozzle and expands the pressure drops drastically and the once liquid carbon dioxide becomes a mixture of dry ice and carbon dioxide gas.

The grinding operation typically entails the use of an abrasive material such as aluminum oxide, silicon carbide, ceramic aluminum oxide, or even diamond attached to a belt. The belt is typically in a loop that is mechanically driven and is run over the surface to be processed in order to remove material to produce the desired finish.

### DETAILED DESCRIPTION OF THE INVENTION

The use of the liquid carbon dioxide for cooling of the workpiece or the abrasive belt was tested by placing a nozzle two inches from the interface between the workpiece and the abrasive grinding surface of the belt. The liquid carbon dioxide was sprayed for the duration of the grinding time.

The temperature of the workpiece, which comprised 304 Stainless Steel, was measured after a control grind during which no coolant or carbon dioxide was used. The temperature of the workpiece following this control test was 97° F. (36.1° C.). During the operation when liquid carbon dioxide snow was directed at the workpiece the temperature was 90° F. (32.2° C.). This 7 degree difference in temperature is significant as it ensures a more efficient grinding operation without the difficulties that a liquid coolant or no coolant at all would encounter.

Further, the largest reduction in temperature when compared to the control was observed in the spark shower. This reduction was almost 100° F. (37.7° C.). This was also visibly apparent as the spark shower with no liquid carbon dioxide spray was much brighter while the spark shower with the liquid carbon dioxide spray was a duller color indicating that significant heat was removed from the process.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what I claim is:

1. A method for cooling a workpiece during a grinding operation of the workpiece comprising spraying liquid carbon dioxide onto the workpiece.

2. The method as claimed in claim 1 wherein the liquid carbon dioxide is fed from a source of liquid carbon dioxide through a nozzle.

3. The method as claimed in claim 2 wherein the source of liquid carbon dioxide is selected from the group comprising liquid siphon tube cylinders, dewars and bulk supply tanks.

4. The method as claimed in claim 1 wherein the liquid carbon dioxide is sprayed at a temperature and a pressure above the triple point of carbon dioxide of −56.6° C. and 5.11 atmospheres.

5. The method as claimed in claim 2 wherein the liquid carbon dioxide expands upon contact with an atmosphere surrounding the workpiece thereby forming carbon dioxide snow.

6. The method as claimed in claim 1 wherein the workpieces are metallic.

7. The method as claimed in claim 6 wherein the metallic workpieces are stainless steel.

8. The method as claimed in claim 1 wherein the liquid carbon dioxide is sprayed during the entire grinding operation.

9. The method as claimed in claim 1 wherein the cooling of the workpiece results in reduction of seven degrees in temperature during the grinding operation.

10. A method for cooling a workpiece during a grinding operation of the workpiece wherein the grinding operation is performed using an abrasive belt comprising spraying liquid carbon dioxide onto a back surface of the abrasive belt.

11. The method as claimed in claim 10 wherein the abrasive belt is held stationary.

12. The method as claimed in claim 10 wherein the liquid carbon dioxide is fed from a source of liquid carbon dioxide through a nozzle.

13. The method as claimed in claim 12 wherein the source of liquid carbon dioxide is selected from the group comprising liquid siphon tube cylinders, dewars and bulk supply tanks.

14. The method as claimed in claim 10 wherein the liquid carbon dioxide is sprayed at a temperature and a pressure above the triple point of carbon dioxide of −56.6° C. and 5.11 atmospheres.

15. The method as claimed in claim 14 wherein the liquid carbon dioxide expands upon contact with an atmosphere surrounding the back surface of the abrasive belt thereby forming carbon dioxide snow.

16. The method as claimed in claim 10 wherein the workpieces are metallic.

17. The method as claimed in claim 16 wherein the metallic workpieces are stainless steel.

18. The method as claimed in claim 10 wherein the liquid carbon dioxide is sprayed during the entire grinding operation.

19. The method as claimed in claim 10 wherein the cooling of the workpiece results in reduction of seven degrees in temperature during the grinding operation.
